(19) United States
(12) Patent Application Publication
(10) Pub. No.: US 2020/0132508 A1
(43) Pub. Date: Apr. 30, 2020

(54) Battery-less multi-turn absolute rotary encoder using capacitor

(71) Applicant: Hui Li, Surrey, CA (US)

(72) Inventor: Hui Li, Surrey, CA (US)

(21) Appl. No.: 16/172,824

(22) Filed: Oct. 28, 2018

(51) Int. Cl. G01D 5/14; H02K 11/215

(52) U.S. Cl. CPC G01D 5/145; H02K 11/215

(57) ABSTRACT

The present invention pertains to a multi-turn rotary encoder that can maintain multi-turn data without the use of a back-up battery. By integrating a capacitor into the main input power circuit of the encoder, the capacitor power can delay the shut off of the encoder microcontroller and sensor, allowing enough time for the rotary motion to stop before storing the single and multi-turn absolute position information. The invention also includes circuits to detect main power shut off and analog circuits to monitor input power voltage. After capacitor voltage drops below certain level, microcontroller saves single and multi-turn position and shuts down. When powering back up, the encoder reads the instantaneous position and compares with previously saved position, then the difference is calculated to determine current multi-turn position to begin normal operation.

This invention relates to rotary encoders used for position or speed feedback mainly on electric motors. In particular, this invention is used to store multi-turn encoder data without the traditional use of batteries.

### BACKGROUND OF THE INVENTION

Rotary encoders are widely used to measure angular position of a rotating mechanical device such as electric motor. A single turn absolute encoder measures the absolute angular position within 1 revolution, dividing 1 revolution into multiple points each with distinct position. The rotating device is attached to a magnet or optically etched disk as actuator. A sensor is mounted on the encoder to detect the absolute single turn position. A multi-turn rotary encoder expands this by allowing multi-rotational data beyond 1 revolution to be stored even after power is shut off to the encoder.

The multi-turn functionality is traditionally carried out by installing a battery on the encoder power. Thus allowing the encoder to remain powered from the battery after main power is shut off. However, using a battery adds extra cost and complexity to the overall system. There are strict requirements on the type of battery that can be used for this purpose. The encoder typically uses an integrated circuit such as a microcontroller as the main controller device. Microcontrollers operate at 3.3V rated voltage so the battery must be 3.6V rated voltage to be able to support proper microcontroller power. 3.6V batteries are relatively expensive and difficult to obtain. Also the battery must be replaced after a certain period as the charge is depleted. Changing the battery can be a difficult task as the battery is often built into other devices or enclosed in a case to protect from environment. The entire control system utilizing the battery multi-turn encoder must also be fully re-set and re-calibrated as the multi-turn data is lost when the battery is removed at any time.

The purpose of this invention is to overcome the difficult use of batteries, while still allowing the encoder to properly and reliably store multi-turn data. By using a dedicated capacitor power circuit to delay microcontroller shut off time and special calculation to retrieve and combine single and multi-turn data, the multi-turn data can be reliably stored and maintained indefinitely without the use of batteries.

### SUMMARY OF THE INVENTION

The advantages of this invention can be realized using a system as depicted in FIG. 1. The encoder rotary is coupled to a rotating mechanical device such as electric motor. As the motor rotates, the encoder rotary rotates and the encoder sensor reads the angular position.

The encoder's main power input is normally a +5 VDC voltage supplied from an external controller. The external controller is the device that makes use of the encoder. Typically, the external controller is a servo drive or amplifier utilizing the encoder to read motor position and speed. A capacitor is placed between the +5 VDC and Ground terminals of the main power input for the encoder. When main power is first turned on, the capacitor charges. The power from the controller will be referred to as Main Power and power from capacitor is called Capacitor Power.

During normal operation, the encoder is powered from the main power. When the controller is shut off, +5 VDC main power is removed. But the super capacitor maintains charge and is able to power the microcontroller independently for a short period. The period from the time main power is shut off to capacitor power shut off will be called Capacitor Power Lifetime (CPL). During CPL, the microcontroller is independently powered by the capacitor power.

The power is sent to both the microcontroller and absolute sensor. The absolute sensor is the source for the encoder position data. During CPL, the power from the capacitor powers both microcontroller and absolute sensor. So the capacitor power can maintain normal position reading and microcontroller operation.

An independent circuit is used for the microcontroller to detect when main power is shut off. An input signal is connect to the microcontroller to notify the when main power is off and microcontroller reacts to this change as necessary. It is desirable and adds to the advantage of the invention to maintain the capacitor power and CPL for as long as possible. So when the microcontroller detects the main power is turned off, it changes the operation state into a low power consumption state. During microcontroller low power state, the frequency of encoder absolute sensor reading and position calculation is significantly decreased to conserve power.

The relation between capacitor capacitance and CPL mainly depends on the microcontroller and absolute sensor power consumption during low power state. Conventional microcontroller low power state power consumption and capacitor capacitance can yield CPL between ten and twenty seconds. This is enough time for the encoder rotor motion to come to a complete stop. The method by which the encoder rotor is stopped is not covered under this invention. Normally, an electromagnetic brake is used to stop and lock the rotary and rotor movement.

A dedicated circuit is connected to the capacitor output and microcontroller A/D input port. This circuit is used by the microcontroller to monitor the voltage level of the input power. The purpose is to monitor the voltage after main power is shut off to detect when the capacitor charge has depleted. When the microcontroller detects the voltage has dropped to a certain level, it triggers a final encoder multi-turn position read and stores the data into EEPROM. Afterwards, the microcontroller safely shuts itself off.

Once the system is ready to power up again, the main power is given. When booting up, the microcontroller initializes the encoder position by reading the previously saved multi-turn data in EEPROM. Then, it reads the current multi-turn position and compares the two values to detect if there was any movement while it was powered off.

When the microcontroller is fully shut down, the hardware connected to the encoder shaft should implement a mechanism to lock and prevent any shaft movement. However, even if the shaft is locked, external factors such as vibration, temperature and external forces may cause the rotor to move slightly. Absolute encoders have very high resolutions so even small changes in the rotor position can lead to large numerical difference in encoder position. So when the encoder is powered up, it should compare the current position to the last saved position in EEPROM to calculate any position change when it was powered off.

The method used to store the multi-turn data as outlined above and method used to calculate the position change during power off only allows half revolution of movement when the microcontroller is powered down. Within half a revolution in both direction, the encoder can correctly determine the difference between the current position and last saved EEPROM position and calculate the current absolute multi-turn data accordingly. Once the encoder has finished this calculation, the encoder sets the current multi-turn position and begins normal operation.

In this invention, the capacitor acts like a very small capacity battery. Instead of the battery, the capacitor is used to maintain power to the encoder when main power is shut off. When capacitor power depletes, the rotor movement should be stopped and locked position.

Although this invention requires the encoder position to be locked when power is shut off, most devices that use multi-turn encoders already implement such a mechanism. For example, industrial robots and automatic guided vehicles often implement electromagnetic brakes on all motors to lock rotary movement when powered off. The capacitor circuit of this invention delays the shut off of the microcontroller and sensor to allow enough time for the rotating motion to stop, then when the rotating motion is stopped and locked, the encoder saves the single and multi-turn position. Without the capacitor power circuit, the microcontroller and absolute sensor could shut off before the rotating motion has stopped, resulting in loss of position.

A typical magnetic encoder absolute sensor can be realized by the following. A single pole permanent magnet actuator is mounted on a rotating device shaft. Two linear hall sensor are mounted beside the magnet in perpendicular direction. As the shaft and magnet turns, one hall sensor will output a sine wave signal and the other hall sensor will output a cosine wave signal. According to the hall sensor sine wave and cosine wave, the controller can calculate the absolute shaft angle in the 360 degree range. Though the scope of this invention does not limit the absolute sensor type. It is also common for the actuator to be an optical etched disk and the sensor is a light sensor to read the etching to determine absolute position. The operation and functionality of this invention is applicable to any absolute sensor type.

### BRIEF DESCRIPTION OF THE DRAWINGS

FIG. 1 is a circuit diagram of the encoder main controller device and power circuit, including a typical absolute sensor, incorporating the embodiment of the present invention's claims. The main controller is represented by a microcontroller.

FIG. 2 is a graphic representation of a magnetic absolute sensor and method by which the single turn absolute position data is calculated from two hall sensors placed perpendicularly around a single-pole permanent magnet rotating about its axis.

FIG. 3 is a graphic representation of the encoder absolute position, used to depict and aid the calculation of single and multi-turn data.

FIG. 4 is a timing diagram showing the functional operating procedure of the embodiment of the invention.

FIG. 5 is a flowchart depicting the comprehensive operation cycle of the invention.

FIG. 6 is a flowchart depicting the method the invention uses to calculate the single turn absolute position.

### DETAILED DESCRIPTION OF THE PREFERRED EMBODIMENT

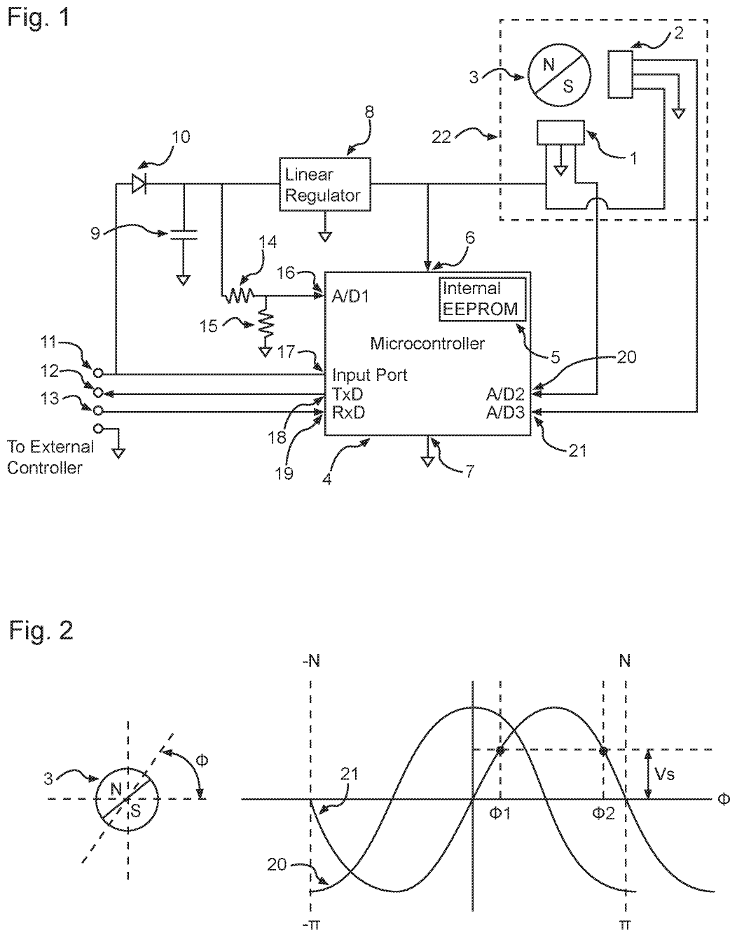

FIG. 1 depicts the full embodiment of all the constituents of the present invention. The main power supply is fed into the system from 11 and split into two circuits along 10 and 17. 10 is a diode to prohibit current flow in the opposite direction. From 10, the power is connect to 9, which is the main capacitor of this invention. The negative leg of 9 is connected to the same ground as the main power supply, effectively charging the super capacitor when main power from 11 is turned on. The main controller device used by the encoder is 4, which can be any integrated circuit such as microcontroller, DSP or FPGA. For the purpose of this patent application, a microcontroller is used as an example. The microcontroller calculates the encoder position from the absolute sensor 22, and controls all the input and output functional logic of the encoder. The microcontroller also interfaces with an internal or external EEPROM memory 5 used to store single and multi-turn encoder data when main power is shut off. When main power is turned on, the microcontroller program reads the previously stored encoder data from EEPROM.

The power from 10 is also connected to a voltage divider circuit realized by 14 and 15 resistors. The voltage divider circuit drops the voltage to a value appropriate for the microcontroller Analog to Digital (A/D) converter input 16. The voltage from the divider circuit is used for the microcontroller to monitor the voltage at the power supply. The power from 10 is also connected to the linear regulator 8. The main power is usually 5V level and the linear regulator regulates the voltage down to 3.3V as required by the microcontroller main power input 6. From the linear regulator output, the power is connected to the microcontroller's main power input 6. The power from 8 also supplies power to the absolute sensor 22. In this example, the absolute sensor uses two linear hall sensors, which are typically powered by 3.3V. This may not be the case for other absolute sensor types so the power from linear regulator may or may not connect to the absolute sensor input power.

Box 22 is a representation of a typical magnetic absolute sensor including the magnet actuator 3 and two linear hall sensors 1 and 2. 1 and 2 linear hall sensors are placed perpendicular to the magnet actuator so as to generate a sine wave signal and cosine wave signal as the magnet is rotated. The power from linear regulator 8 is connected to both hall sensor supply power. The two linear hall sensors outputs an analog signal as the magnetic flux from the actuator is rotated and changed. As the actuator rotates one revolution, one sensor outputs a sine wave signal 21 and the other perpendicular sensor outputs a cosine wave signal 20. The actuator rotation and hall sensor output waveform is depicted in FIGS. 2.

12 and 13 is the encoder interface to an external controller. Typically, this is a serial communication consisting of a send and receive signal. The microcontroller sends data from 18 out to the external controller via 12. The external controller sends data to the encoder microcontroller from 13 and received by the microcontroller at 19. All components on the circuit uses the same reference ground 7.

FIG. 4. Is a timing diagram depicting the step by step functional operation of the main power voltage, super capacitor voltage, microcontroller operation and EEPROM read/write operation. The encoder operation starts at 26. At timing 26, the main power 11 is turned on. After which the capacitor 9 charges, reads EEPROM multi-turn position 35, and microcontroller initializes and begins normal operation 33.

At timing 27, the main power is shut off. When the main power is shut off, microcontroller input at 17 detects this change and switches to low power operation mode 34. At the same time, the microcontroller begins monitoring the A/D input 16. Once main power is shut off, the potential difference at the positive side of super capacitor 9 is biased positive and current flows from 9 to power the microcontroller at 6 and at absolute sensor 22. As the super capacitor discharges, the voltage output drops in relation to time.

Vth1, 31 and Vth2, 32 are two threshold super capacitor voltages used to represent critical voltage levels to which the microcontroller should react to. As the super capacitor discharges, the voltage drops and the microcontroller reacts when voltage drops to Vth1 and Vth2.

At timing 28, the super capacitor voltage has dropped to Vth1. At this time, the microcontroller should be programmed so that it triggers a write operation to the EEPROM 36. This write operation reads the current single turn and multi-turn absolute encoder position data and saves this data into EEPROM appropriately. Afterwards, the microcontroller idles for a period 38. At timing 29, the super capacitor voltage has dropped to Vth2. When this is detected by the microcontroller, it activates an internal trigger to fully and safely shut down operation 37.

At timing 30, the main power is turned on again and the cycle can be continued again per timing 26. The main power can be turned on regardless of the super capacitor voltage. It is possible for the main power to be turned on during time period 38. During 38, the super capacitor voltage has dropped below Vth1, but not dropped to Vth2. Meaning the microcontroller has stored the position into EEPROM, but not yet fully powered down. During this idle time, the microcontroller should still monitor the input 17 and analog voltage 16. If the main power is turned on during 38, the microcontroller should detect this and go back into normal operation 33.

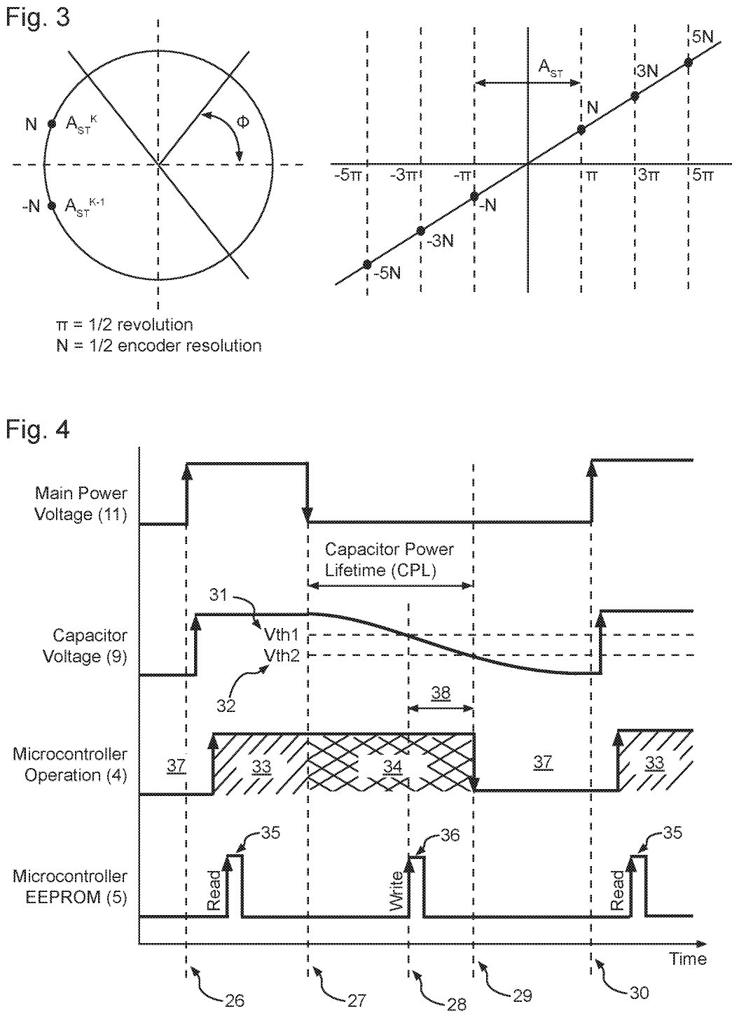

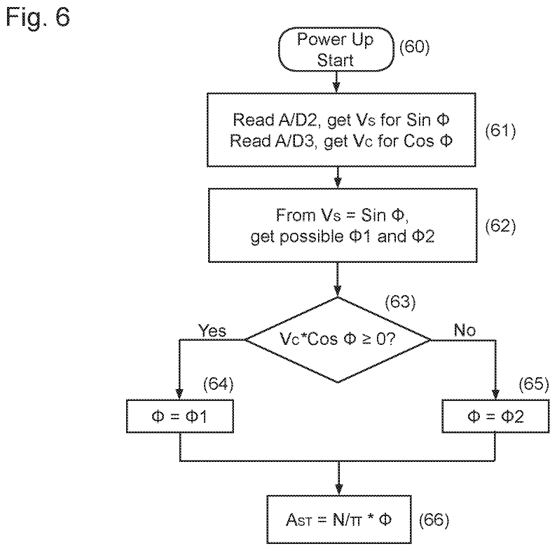

The single turn position A_{ST} is calculated according to FIG. 6, aided by FIG. 2 and FIG. 3 to depict the angular position. The single turn calculation starts at 60. First, the two linear hall sensor data is read 61. The two signals are read from A/D inputs at A/D2 20 and A/D3 21. The sine signal 21 is assigned to variable V_{S} and cosine signal 20 is assigned to V_{C}. Per FIG. 2, from the value of V_{S} there can be two possible angular positions ϕ1 and ϕ2 62. At this point, the actual angular position can be either ϕ1 or ϕ2. Then, a calculation is done to see if V_{C} multiplied by cosine ϕ1 is greater than or equal to zero 63. If it is, then the actual angular position is ϕ1, so actual angular position ϕ is set to ϕ1 64. If not, actual angular position is set to ϕ2 65. The final single turn position is A_{ST} is calculated per 66. N is half the full encoder resolution. For example, if the resolution is 4096, N=2048. So the final value of A_{ST} gives is the single turn absolute position in units of encoder resolution.

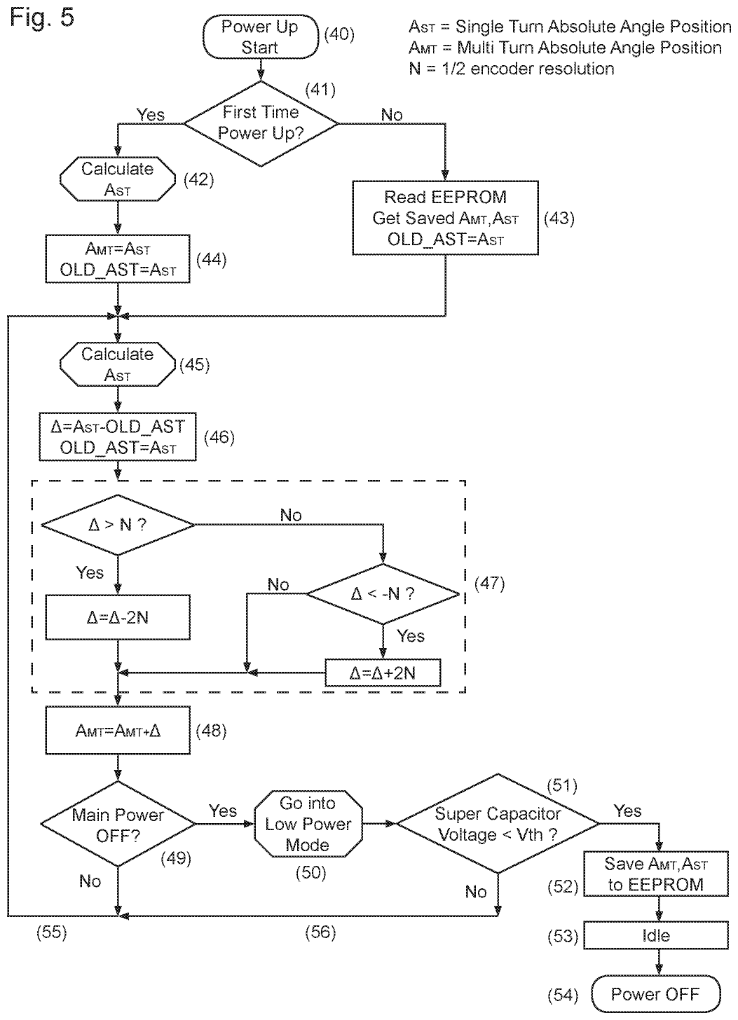

The full operation cycle of the invention is depicted in FIG. 5 as a flowchart diagram. The encoder is powered up at 40. Then a check is made to see if this is the first time the encoder is used 41. If it is the first time, the single turn absolute position A_{ST} is calculated per FIG. 6. Then the multi-turn absolute position A_{MT} is set to A_{ST} 44, and variable OLD_AST is also set to A_{ST}. If it is not the first time being powered 43, the previously stored EEPROM position for A_{ST} and A_{MT} is retrieved and a variable OLD_AST is set as the retrieved A_{ST} data. Then 45 measures and calculates the current AST position per FIG. 6. 46 calculates the change Δ between the current A_{ST} position and previous AST position OLD_AST, then sets OLD_AST as current A_{ST}, as read at 45, for the next cycle. Box 47 depicts the method used to calculate the absolute position change. Then the multi turn absolute position A_{MT} is set to the previous A_{MT} position plus the change Δ 48. Finally at 49, the encoder checks to see if the main power is shut off. If not, the operation cycles back to 45 to calculate the single turn position again. Under normal operation, the encoder continuously runs within cycle 55 to continuously read and update the multi-turn position.

At 49, if it is detected that the main power is shut off, the encoder is put into a low power state 50. After the encoder goes into low power state, it monitors the capacitor voltage 51. If the voltage is above the threshold voltage V_{TH1}, it follows cycle 56 back to 45 to continue normal operation. If the super capacitor voltage is below V_{TH1}, it saves the single and multi-turn absolute position into EEPROM 52, idles until capacitor voltage drops below V_{TH2} 53, then powers off 54.

Timing diagram FIG. 4 and operation flow FIG. 5 can be combined to achieve consolidated operation description of the invention. At 26, the main power is turned on, corresponding to 40. Then the encoder reads EEPROM data for A_{ST} and A_{MT} at 35 and 43. During normal operation 33, the encoder runs cycle 55 to continuously read and update the position data. At time 27, the main power is turned off, which is detected by 49 and goes into low power state according to 50 and 34. The super capacitor voltage is monitored at 51 to see if the voltage has dropped below V_{TH1}. During this time, the encoder runs low power cycle 56 to continue reading and updating encoder position. At time 28, the super capacitor voltage drops below V_{TH1}, which is detected by 51. Then the encoder saves current A_{ST} and A_{MT} position into EEPROM per 36 and 52. As the capacitor voltage continues to drop, the encoder program idles at 38 and 53. Power is fully shut off when voltage drops below V_{TH2} at 29 and 54.

What is claimed is:

1. A battery-less multi-turn rotary encoder comprising: a capacitor power circuit to maintain power to the encoder microcontroller when main input power is shut off; a power circuit from the capacitor to the absolute position sensor so that when main input power is shut off, the capacitor power can maintain power to the absolute position sensor.

2. The battery-less multi-turn rotary encoder in accordance with claim 1, where a dedicated circuit is used by the microcontroller to detect when the main input power is switched off.

3. The multi-turn rotary encoder in accordance with claim 1, where the capacitor and main power input are both connected to a linear regulator, where the regulator outputs a fixed DC voltage for the microcontroller and absolute position sensor.

4. The multi-turn rotary encoder in accordance with claim 1, where the main power input and capacitor power is connected to a microcontroller A/D input port, with or without a divider circuit with a parallel capacitor, so the microcontroller can read and monitor the voltage of main input power or capacitor power.

5. The multi turn rotary encoder in accordance with claim 1, where after the main input power is switched off, a capacitor voltage independently supports the encoder operation, and when capacitor voltage drops below a certain level, the microcontroller saves current single and multi-turn position to microcontroller internal or external memory.

6. The multi turn rotary encoder in accordance with claim 1 where the microcontroller is instead a microprocessor, DSP, FPGA or any type of integrated circuit that can be used to calculate encoder position and has the I/O peripherals necessary to support operation per claims 1˜5.
